(19) United States
(12) Patent Application Publication
(10) Pub. No.: US 2026/0303602 A1
(43) Pub. Date: Oct. 1, 2026

(54) ONLINE EDITING FOR A CONTENT MANAGEMENT SYSTEM

(71) Applicant: OPEN TEXT INC., Menlo Park, CA (US)

(72) Inventors: Pardeep Kumar, Bangalore (IN); Divisha Nikunj Varandani, Bengaluru (IN); Mithun Karkada Sathisha, Bangalore (IN)

(21) Appl. No.: 19/635,662

(22) Filed: Mar. 31, 2026

(30) Foreign Application Priority Data
Mar. 31, 2025 (IN) 202541031565

(51) Int. Cl. H04L 9/40; G06F 9/451

(52) U.S. Cl. CPC H04L 63/101; G06F 9/452; H04L 63/108

(57) ABSTRACT

Systems and methods enable browser-based online editing and real-time co-authoring of documents stored in on-premises content management systems using a cloud-based online editor without permanently moving the documents to the cloud. An on-premises Online Editing Service (OES) connector service, together with an event hub, notification database, notification service, and heartbeat monitoring, bridges the on-premises repository with the cloud-based editor while preserving on-premises permissions, versioning, and document control. In another embodiment, native desktop client applications are directly integrated with the on-premises repository through the cloud-based online editing infrastructure. A remote editing service server authenticates with the OES connector service, which validates on-premises user permissions and provides an authorized folder structure and documents directly to the native desktop client.

### CROSS-REFERENCE TO RELATED APPLICATIONS

This application claims priority under 35 U.S.C. § 119 to Indian Patent Application No. 202541031565, filed Mar. 31, 2025, entitled “ONLINE EDITING FOR A CONTENT MANAGEMENT SYSTEM,” the contents of which are fully incorporated by reference herein for all purposes.

### FIELD OF THE INVENTION

The subject disclosure relates generally to content management systems. More particularly, the subject disclosure relates to systems and methods for enabling browser-based online editing and real-time co-authoring of documents. In some embodiments, the documents to be edited are stored in on-premises (on-prem) content management systems using a cloud-based online editor without moving the document to the cloud. In additional embodiments, the disclosure provides direct integration of native desktop client applications with the on-prem repository through the cloud-based online editing infrastructure.

### BACKGROUND

Online, cloud-based editors have become popular tools for editing and collaborating on documents. In a common scenario, an online service, which may be referred to as a software-as-a-service (SaaS) application, provides users with a browser-based editing client that the users can use to edit documents, sometimes simultaneously. The documents available for editing in this manner are stored and managed by the SaaS provider (i.e., the documents reside “in the cloud”), though local copies may be synchronized to end-user devices, and users access documents based on having personal accounts with the SaaS provider or being members of a tenant at a multi-tenant system with the online service enforcing permissions for the individual users with respect to the online documents.

Many enterprises, however, are hesitant to store sensitive or business critical information in the cloud and use on-prem content management systems to handle their content. An on-prem content management system is deployed within an organization’s own facilities or behind its firewall, rather than being hosted in the cloud. On-prem systems typically do not support online, browser-based editing of documents. Instead, users must download documents from the content management system to their own computers and edit the documents using native applications (e.g., a desktop word processing software). During editing by one user, the content management system locks the document on the server to prevent simultaneous editing by other users. Thus, while on-prem systems can provide advantages with respect to control, customization, and performance, among other advantages, they often sacrifice accessibility and convenience.

### SUMMARY

In some embodiments, the subject disclosure is directed to an online editing service (OES) connector service that enables browser-based online editing and real-time co-authoring of documents stored in on-premises content management systems using a cloud-based online editor without permanently moving the document to the cloud. The OES connector service, together with an event hub, notification database, notification service, and heartbeat monitoring, bridges the on-prem repository with the cloud platform while preserving on-prem control, permissions, and versioning.

In other embodiments, the subject disclosure provides direct desktop client integration with the on-prem repository through the cloud-based online editing infrastructure. A user logs into a native desktop client application. The desktop client sends the login information to a remote editing service server (e.g., the server associated with the online editor). The remote editing service server authenticates with the OES Connector Service using an authentication token. The OES Connector Service validates the user’s on-premises permissions in the content management system (e.g., DCTM/Documentum repository). Once validated, the authorized folder structure and documents are provided directly from the on-prem storage to the native desktop client through the remote editing service server and the OES Connector Service. This architecture securely bridges non-cloud-native desktop applications with private on-prem repositories while preserving security and permissions controls and eliminating the need for the user to route through a web-based client. The subject disclosure improves the functioning of the content management system by enabling real-time co-authoring while preserving on-prem versioning and permission controls without permanent document migration to the cloud.

In the browser-based embodiment, the OES connector service is used with an event hub, notification database, and heartbeat monitoring as described herein. The subject disclosure improves the functioning of a computer system by eliminating the need for end-user cloud accounts, thus improving security, while providing native desktop editing with on-premises control and real-time co-authoring.

### BRIEF DESCRIPTION OF THE DRAWINGS

The drawings accompanying and forming part of this specification are included to depict certain aspects of the invention. A clearer impression of the invention, and of the components and operation of systems provided with the invention, will become more readily apparent by referring to the exemplary, and therefore non-limiting, embodiments illustrated in the drawings, wherein identical reference numerals designate the same components. Note that the features illustrated in the drawings are not necessarily drawn to scale.

FIG. 1 is a diagrammatic representation of one embodiment of a network environment in which online editing and collaboration on documents managed by an on-prem content management system is supported.

FIG. 2 is a high-level architecture diagram illustrating the OES connector service, notification database, event hub, notification service, and secondary OES Service bridging the client and cloud-based online editor (alternative browser embodiment).

FIG. 3 is a data flow diagram illustrating the detailed sequence of operations for online editing, permission checking, event persistence, heartbeat monitoring, and automatic check-in.

FIGS. 4A, 4B, and 4C illustrate screenshots of a web browser being used according to one embodiment online editing of a file managed by an on-prem content management system.

FIG. 5 is a sequence diagram illustrating an embodiment of the direct desktop client integration embodiment showing login flow, token authentication with the OES Connector Service, permission validation, and direct provision of folders/documents from on-prem DCTM storage via the remote editing service server to the desktop client.

FIG. 6 is a high-level architecture diagram of the direct desktop client integration embodiment.

### DETAILED DESCRIPTION

Embodiments and the various features and advantageous details thereof are explained more fully with reference to the non-limiting embodiments that are illustrated in the accompanying drawings and detailed in the following description. Descriptions of well-known starting materials, processing techniques, components and equipment are omitted so as not to unnecessarily obscure the embodiments in detail. It should be understood, however, that the detailed description and the specific examples are given by way of illustration only and not by way of limitation. Various substitutions, modifications, additions and/or rearrangements within the spirit and/or scope of the underlying inventive concept will become apparent to those skilled in the art from this disclosure.

Embodiments of the present disclosure provide systems and methods to enable online editing and collaboration on files (e.g., documents) managed by content management systems, such as, but not limited to, on-prem content management systems that do not natively provide online editing and collaboration.

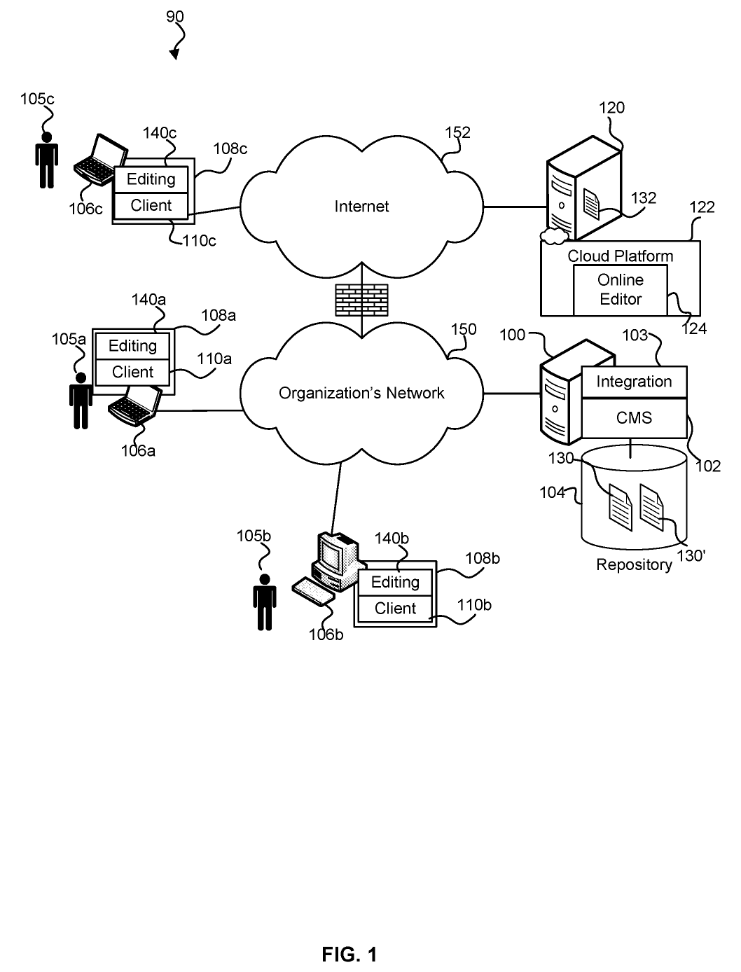

FIG. 1 is a diagrammatic representation of one embodiment of a network environment 90 comprising an on-prem server 100 (e.g., one or more server computers) that executes an on-prem content management system (CMS) 102 used by an organization to manage a document repository 104 that is private to the organization. CMS 102 may provide features such as search and retrieval, access controls (enforcing permissions to control which users can view, edit, or perform other operations on documents), check-in/check-out (locking a document when a user checks out the document to prevent others from simultaneously editing the document and unlocking the document when the document is checked back in), version control, workflow management, among other features. One example of a content management system may be provided by the OPEN TEXT DOCUMENTUM content management platform (all trademarks, tradenames, service marks and the like used herein are the property of their respective owners). Each server and computing device described herein comprises at least one processor and associated memory configured to execute the disclosed operations.

Client devices 106 (e.g., client device 106a, client device 106b, client device 106c are illustrated) are communicatively coupled to server 100 by a network, such as a local area network (LAN), wide area network (WAN) (e.g., the Internet), or other network or combination of networks. Network environment 90 may include internal client devices and external client devices. Internal client devices (e.g., client device 106a and client device 106b) are behind the organization’s firewall and are coupled to an organization’s LAN 150, which may comprise one or more virtual LANs (VLANs) in one embodiment. External client devices (e.g., client device 106c) are outside of the organization’s firewall and connect to server 100 over the Internet 152. A virtual private network (VPN), port forwarding, application proxy, or other techniques can be used to provide external client devices access to CMS 102.

The client devices 106 include a web browser 108 (e.g., web browser 108a, web browser 108b, web browser 108c). A client application 110 (e.g., client application 110a, client application 110b, and client application 110c) for interacting with CMS 102 can be launched in a browser window to provide functionality for accessing documents or performing other operations with respect to documents in repository 104. In other embodiments, one or more of the client applications 110 is a desktop application or mobile application that executes independently from the web browser.

Network environment 90 also includes a cloud computer system 120 that implements a cloud platform that supports various cloud services including an online editor 124 for online editing of documents. Online editor 124 may further support collaboration between users by allowing co-authoring (co-editing) of documents. Examples of cloud-based services for online editing include, but are not limited to, online word processors, online spreadsheet applications, and online presentation editors for creating and editing slide-based presentations. In some embodiments, cloud platform 122 provides a cloud-based, integrated business application suite that includes a word processor, a spreadsheet application, a presentation application, etc. Cloud platform 122 may be a commercially available cloud platform provided by a third party.

CMS 102 interfaces with cloud platform 122 to allow users at client devices 106 to use online editor 124 for editing and collaboration on documents from document repository 104 while retaining on-prem control of the documents. In some embodiments, CMS 102 includes or is coupled to an integration layer 103 that comprises one or more layers of services, connectors and data stores (e.g., database or other storage) to interface between CMS 102, client applications and cloud platform 122.

In operation, a user at a client device uses a client application 110 to select a document from repository 104 for online editing using online editor 124. CMS 102 checks whether the user is authorized to edit the document using the online editing tool. In some embodiments, any user who is authorized to edit the document is authorized to edit the document online editor 124. In other embodiments, CMS 102 enforces separate permissions for editing using a local application (e.g., a local application on the user’s client device) or client application for CMS 102 and online editing such that, for example, a user having permission to edit a document using a browser-based client application 110 provided by CMS 102 or a native desktop application may not have permission to edit the document online using online editor 124. In some embodiments, a document in repository 104 may be excluded from online editing such that no user has the option to edit the document online using online editor 124.

If the user selects to edit a document online and has authorization for online editing of the document, CMS 102 checks out the document (locks the document), uploads the document to cloud platform as an online version of the document (online document), and provides user information about the user to cloud platform 122. For example, CMS 102 provides information such as the user’s name, email address, picture or other available metadata about the user. Cloud computer system 120 returns document access information for the online copy of the document to CMS 102 and CMS 102 returns the document access information to the user’s client application 110. The document access information includes a URL for accessing the online version of the document. In some embodiments, the document access information includes an authorization token for the user, which may be part of the URL or otherwise accompany the URL.

The web browser 108 on the user’s client device 106 uses the document access information to access the cloud-hosted document. Using the URL causes a browser-based editing client 140 (e.g., browser-based editing client 140a, browser-based editing client 140b, browser-based editing client 140c) provided by cloud platform 122 to launch in a browser window for editing the online document. The authentication token can be provided to cloud platform 122 (e.g., as part of or accompanying the URL) so that the browser-based editing client 140 that is launched can access the online document for editing through online editor 124. The browser-based editing client 140 interacts with online editor 124 to provide editing functionality for editing the online document.

If a subsequent user selects to edit the document online and has authorization for online editing of the document, but the document is locked for online editing, CMS 102 notifies cloud platform 122 that another user wishes to collaborate on the document and provides user information about the user to cloud platform 122. Cloud platform returns responsive document access information to CMS 102. In some embodiments, the document access information provided for a subsequent user seeking to co-edit a document online includes a new URL or authentication token that is different from that provided to prior users editing the document online. A web browser 108 on the subsequent user’s client device 106 uses the document access information to access the cloud-hosted document. Using the URL causes a browser-based editing client 140 provided by cloud platform 122 to launch in a browser window for editing the online document. The authentication token provided for the user allows the browser-based editing client 140 to access the desired online document for editing through online editor 124.

For example, if user 105a at client device 106a uses client application 110a to select document 130 from repository 104 for online editing, CMS 102 checks whether user 105a is authorized to edit the document using online editor 124. If user 105a is authorized to edit document 130 online, CMS 102 locks document 130, uploads a copy of document 130 to cloud platform 122 as an online version of the document (online document 132) and provides information about the user 105a who will access the document, such as the user’s email address, name, picture, or other user information. Cloud platform returns document access information for the online document 132 to CMS 102 and CMS 102 returns the document access information to client application 110a.

Web browser 108a on client device 106a of user 105a uses the document access information to access online document 132. Using the URL causes browser-based editing client 140a to launch in a browser window. The authentication token provided to web browser 108a can be provided to cloud platform 122 so that browser-based editing client 140a can access online document 132 for editing through online editor 124. User 105a can interact with browser-based editing client 140a, which in turn interacts with online editor 124 to edit online document 132.

If user 105b also selects to edit document 130 online, but document 130 is locked for online editing, CMS 102 checks whether user 105b is authorized to collaborate on the file online. For example, the owner of the document or user with sufficient privileges may grant other users (e.g., user 105b, user 105c) permission to collaborate on the file. If user 105b is authorized to collaborate on the file, CMS 102 notifies cloud platform 122 that another user wishes to collaborate on the document and provides user information for user 105b to cloud platform 122. Cloud platform 122 returns responsive document access information to CMS 102 and CMS 102 returns the document access information to web browser 108b. Web browser 108b uses the document access information to access online document 132. Using the URL causes browser-based editing client 140b to launch in a browser window. The authentication token provided for user 105b allows browser-based editing client 140b to access online document 132 for editing through online editor 124. Consequently, user 105b can co-edit online document 132 with user 105a. A similar process can be performed to allow user 105c to co-edit online document 132.

According to one embodiment, editing and co-editing of online document 132 is handled by cloud platform 122, which may be a commercially available third-party platform in some embodiments. Cloud platform 122 may track the user sessions in which online document 132 is open and provide status information for consumption (e.g., via an application programming interface (API)) or another interface. Thus, while CMS 102 may, in some embodiments, not track individual edits to online document 132 as they occur, CMS 102 may detect that online document 132 is no longer being edited, such as when the last session in which online document 132 was being edited is closed. When CMS 102 detects that there is no open session with respect to online document 132, CMS 102 downloads online document 132. According to one embodiment, CMS 102 stores the downloaded copy of online document 132 as a new version of document 130 (e.g., as document 130’), releases the lock on document 130, and deletes online document 132 from cloud platform 122.

Cloud platform 122 can provide a variety of useful functionalities with respect to online document 132, such as maintaining a backup of online document 132 until it is deleted. In some embodiments, CMS 102 does not delete online document 132 from cloud platform 122 until repository storage of document 130’ is confirmed (e.g., using checksum). Thus, cloud platform 122 serves as a backup for changes until repository storage of the edited document is confirmed. Further, cloud platform 122 can implement redundant storage solutions to prevent data loss. Cloud platform bmay implement auto-saving changes to online document 132, thereby ensuring that edits are not lost if there is a disruption to service. CMS 102 can store events from cloud platform 122 to persistent storage to ensure recovery in case of downtime due to unavailability of servers.

In some embodiments, cloud platform 122 performs document check-in and check-out for online editing using a system-generated user (e.g., a service user). Thus, even when there are multiple collaborators co-editing online document 132, storing and checking-in document 130, 130’ can be done under a single user.

CMS 102 may further perform continuous monitoring of response time, throughput, error rate and resource utilization, etc., to recommend performance improvements. CMS 102 can include heartbeat monitoring to ensure action upon missing events.

In some embodiments, on-prem content management system CMS 102 or component thereof (e.g., a component of integration layer 103) is registered with cloud platform 122 such that neither the end-users 105 nor the organization implementing CMS 102 to manage its documents need accounts with cloud platform 122 for the users 105 to take advantage of online editing and collaboration on documents managed by CMS 102.

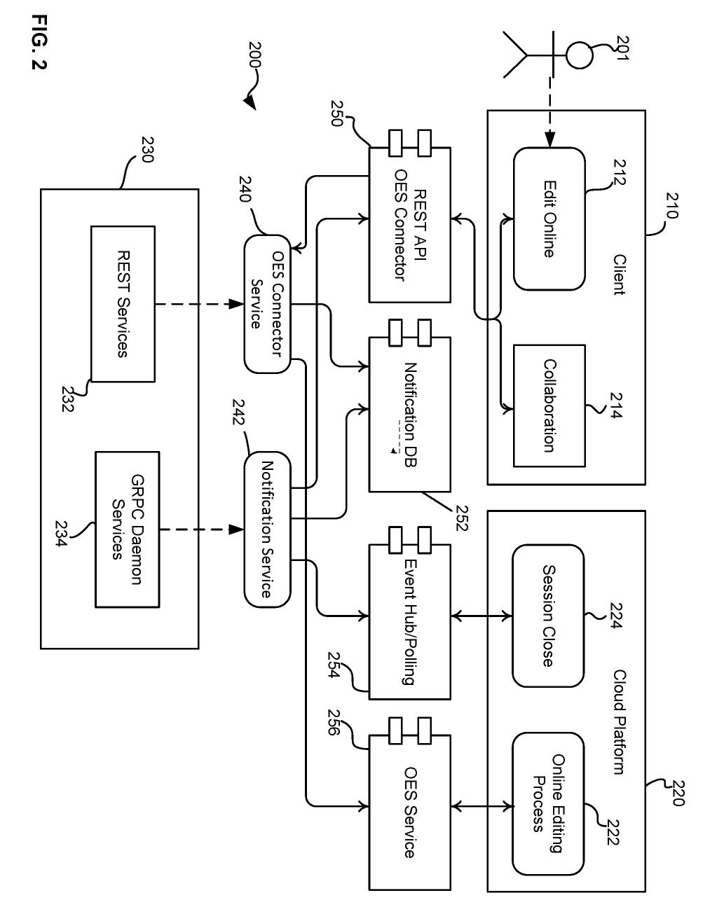

FIG. 2 illustrates one embodiment of an architecture 200 for leveraging a cloud platform 220 to enable online editing 212 and co-authoring capability (collaboration 214) at client 210. Cloud platform 220 may support a variety of cloud services including, for example, an online editing process 222 for online editing of files. Cloud platform 220 publishes events associated with sessions for editing or collaborating on documents (e.g., session close events 224). Cloud platform 220 may represent one embodiment of cloud platform 122.

Architecture 200 allows users to edit and collaborate on files (e.g., documents) managed by a content management system, such as an on-prem content management system. In one embodiment, client 210 is a web browser (e.g., a web browser 108) that can execute browser-based applications for interacting with content management system 230 to access files and with cloud platform 220 for online editing and collaboration.

CMS 230 manages a repository (e.g., document repository 104 of FIG. 1) and provides features such as search and retrieval, access controls (enforcing permissions to control which users can view, edit, or perform other operations on files), check-in/check-out (locking a file when a user checks out the file to prevent others from simultaneously editing the file and unlocking the file when the file is checked back in), version control, workflow management, among other features.

CMS 230 provides a set of services including, but not limited to, Representational State Transfer (REST) services 232 to service REST calls and daemon remote procedure call (RPC) services 234 (and more particularly, in one embodiment, GRPC services) to service RPCs. In the embodiment illustrated, REST services 232 include an online editing service (OES) connector service (OES connector service 240) and daemon RPC services 234 include a notification service 242. OES connector service 240 provides an API (e.g., REST API connector 250) that is consumed by client 210. OES connector service 240 may further include a connector service database (not shown). OES connector service 240 manages a variety of data including, for example, actions and events generated by user interaction with the user interface, mappings of file IDs used by cloud platform 220 to file IDs in the CMS repository, mappings of URLs provided by cloud platform 220 to file IDs in the CMS repository and data used in persistence management.

Architecture 200 further includes a notification database 252, an event hub 254, and an OES Service 256. Event hub 254 consumes events published by cloud platform 220, such as events related to sessions. Notification service 242 can consume the events from event hub 254 and write the events to notification database 252. OES connector service 240 receives events from client 210 via REST API connector 250 and reads events from notification database 252 and creates tasks from the events. The tasks may be sent to a multi-threaded task pool. The tasks are executed by components of architecture 200 to perform various operations (e.g., check-out a file, check-in a file, upload a file, download a file, etc.). OES Service 256, for example, can execute events to upload files and download files and return file access information for uploaded files (e.g., return the URL for an uploaded file).

In one example implementation, OES Service 256 is registered with cloud platform 220 as a service that can upload files to and download files from cloud platform. Event hub 254 may also be Registered to allow event hub 254 to make calls to cloud platform 220 to collect events. CMS or components of the integration layer are registered with cloud platform 220 as an integration. According to one embodiment, so long as the components of architecture that interact with cloud platform 220 are current valid integrations, the end users (e.g., end user 201) or the organization implementing CMS 230 do not need accounts with cloud platform 220 to use online editing process 222 for online editing and collaboration.

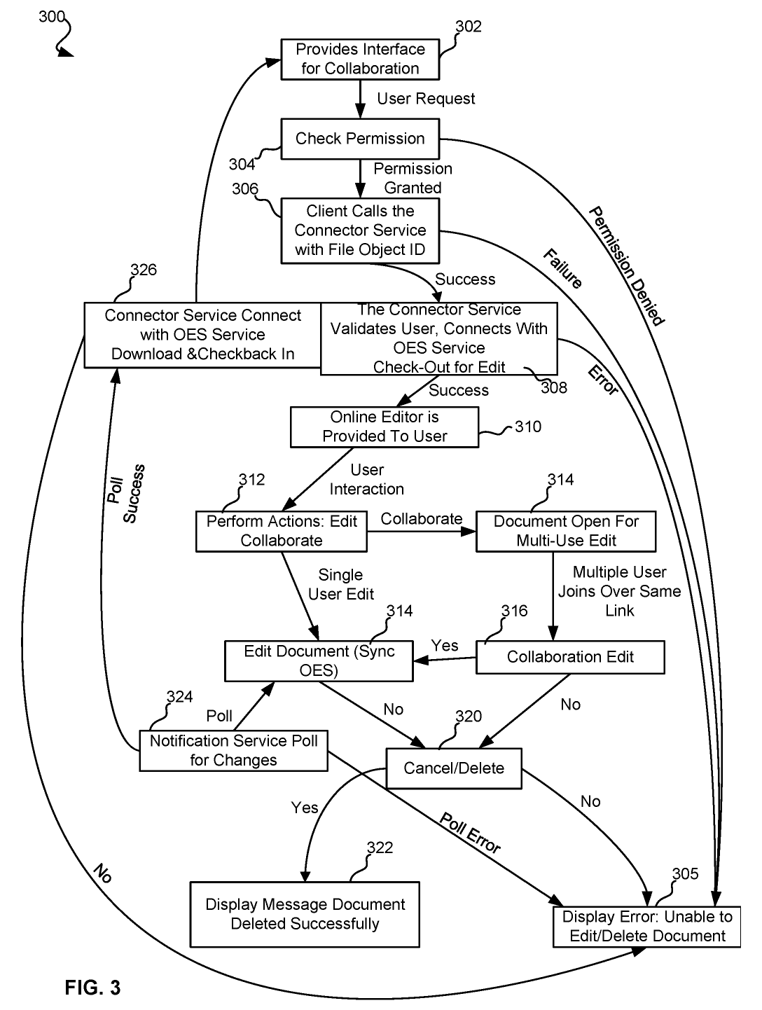

FIG. 3 illustrates one embodiment of a data flow 300 using the example architecture 200. Flow 300 may be implemented using software, hardware or a combination of software and hardware. In some embodiments, flow 300 may be embodied as computer code on a non-transitory computer medium, where the code is translatable by a processor to perform steps of flow 300. Flow 300 may be performed by an exemplary system such as by applications or services that run on one or more servers. However, flow 300 is not limited to such examples.

At operation 302, client 210 provides an interface that allows user 201 to navigate files in a repository managed by a content management system 230. For example, the interface may be provided by a browser-based client application. Based on user interaction with the interface, client 210 generates a user request to edit or collaborate on a file online.

At operation 304, the permissions for the user to online edit or collaborate on the file are checked. If the user does not have permission to online edit or collaborate on the file, the user interface can display an error message, such as “Unable to Edit Document” (operation 305).

If permission is granted, client 210 calls OES connector service 240 via REST API connector 250 and provides the file object ID for the file to OES connector service 240 (operation 306) and requests that OES connector service 240 initiate online editing/collaboration with cloud platform 220. If the call fails, REST API connector 250 can return an indication of the failure to client 210 and the user interface can display an error message, such as “Unable to Edit Document” (operation 305).

At operation 308, OES connector service 240 validates the user and connects to OES Service 256. If OES connector service 240 cannot validate the user connect to the OES Service 256, OES connector service 240 returns and indication of the failure to client 210 via REST API connector 250 and the user interface can display an error message, such as “Unable to Edit Document” (operation 305). OES service 256 checks out the file from the repository and uploads the file to the online editor (online editing process 222) for editing. Online editing process 222 can return file access information. OES connector service brequests file access information from OES Service 256 and returns the file access information to client 210.

Using the example of online editing/collaboration using the MICROSOFT 365 online platform for editing a Word document, the online editing process 222 returns an XML file for configuration of the editor with a respective URL for accessing the file of interest (e.g., online document 132). The URL includes a valid authentication token.

At operation 310, OES connector service 240 provides file access information to client 210. For example, OES connector service 240 provides the URL. Client 210 uses the URL to access cloud platform 220 and, more particularly, online editing process 222. Using the URL can cause, for example, a browser-based editing client to be launched in the web browser. The authentication token that was provided can allow the browser-based editing client that is launched uses the URL to access the desired file (e.g., online document 132).

At this point, content is streamed directly from online editing process 222 to client 210. At operation 312, end user 201 can perform actions with respect to the file such as editing the file or requesting collaboration. End user 201 may make a single-user edits without collaboration. If end user 201 selects to collaborate, client 210 may request that other users join to edit and the file is open for multi-user edit, such as by granting the other users collaboration permissions (operation 314). Multiple users can join to edit the file and thus users may make collaboration edits (operation 316).

If user 201 elects not to save the single user edits or collaboration edits to the file, client 210, at operation 320, attempts to cancel the edits and delete the file from cloud platform 220. If the file is not successfully deleted, client 210 returns an error, such as “Unable to Delete Document” (operation 305). If the file is successfully deleted, client 210 can return a message that the file was successfully deleted (operation 322).

Cloud platform 220 publishes events related to files uploaded by OES Service 256 to event hub 254. For example, cloud platform 220 provides notifications of when sessions associated with files close. Notification service 242 continually polls event hub 254 for events, such as session close events (operation 324). In one embodiment, notification service 242 writes the events to notification database 252 to persistently store the events. This can help ensure recovery in case of downtime to unavailability of services.

If there is a polling error, notification service 242 can provide a notification to REST API connector 250, which can provide the notification to client 210 and client 210 can display a message in the user interface, such as “Unable to Delete Document” (operation 305).

OES connector service 240 may read notifications (events) from notification database 252. If OES connector service 240 detects that all the sessions associated with the file have been closed (e.g., based on file ID), OES connector service 240, at operation 326, connects to OES Service 256 to cause OES Service 256 to download the file from online editing process 222. OES Service 256 downloads the file (e.g., downloads a copy of online document 132), stores the downloaded file in the repository as a new version of the file, and checks the file back in. OES Service 256 further interacts with cloud platform 220 to delete the online copy of the file. In some embodiments, OES Service 256 does not cause cloud platform 220 to delete the online copy of the file until the downloaded copy has been successfully stored to the repository. If the file cannot be downloaded, checked in and deleted, client 210 can display a message in the user interface, such as “Unable to Delete Document” (operation 305).

FIG. 3 is merely an illustrative example, and the disclosed subject matter is not limited to the ordering or number of steps illustrated. Embodiments may implement additional steps or alternative steps, omit steps, or repeat steps.

As discussed, OES connector service 240 can detect when document editing has completed based on polling. If communication with cloud platform 220 is disrupted due to a network failure, outage, or other cause, there may be a delay between events. If no events are received from cloud platform 220 for a specified amount of time, notification service 242 may publish a message to notification database 252 requesting an indication of whether one or more sessions are still active. OES connector service 240 can pick up the notification from notification database 252 and connect to OES Service 256 to cause OES Service 256 to query cloud platform 220 as to whether the session is still active. Consequently, the system can maintain awareness of the status of sessions when, for example, a session is still active but there has not been activity in the session for some time.

In embodiments discussed above, OES connector service 240 generates tasks to download the online version of the file, store the downloaded file to the repository, check in the file and delete the file from cloud platform 220 once it is detected that all sessions on the online file are closed based on notifications from cloud platform 220. Thus, if ten users collaborate on a file using cloud platform 220, OES connector service 240 will wait until the sessions for all ten users are closed before generating the tasks to download the online version of the file and store it to the repository, check in file and delete the file from cloud platform 220. In another embodiment, OES connector service 240 generates a task to download the online version of the file and store it to the repository each time a user session on the file is closed. OES connector service 240 may, however, wait until all the user sessions are closed to generate tasks to check in the file and delete the file from cloud platform 220.

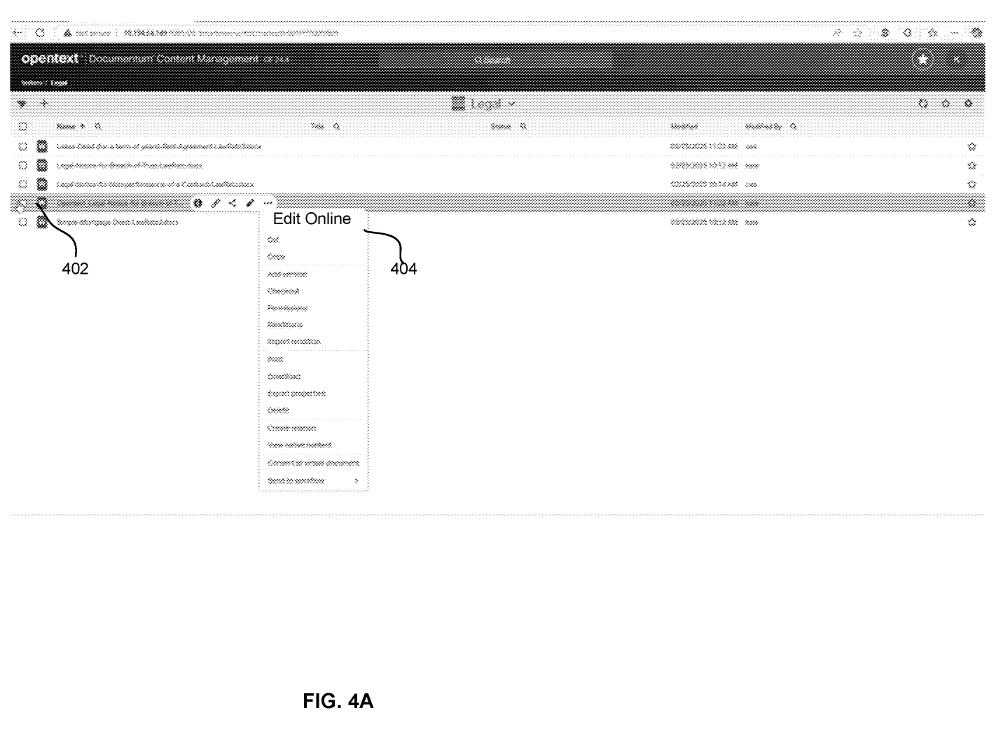

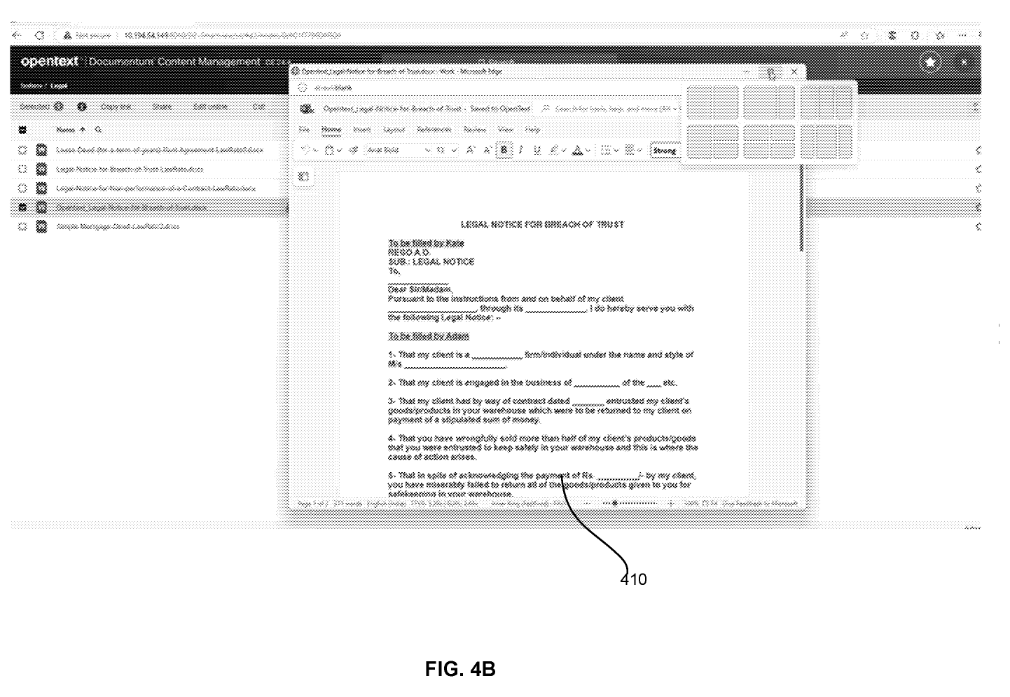

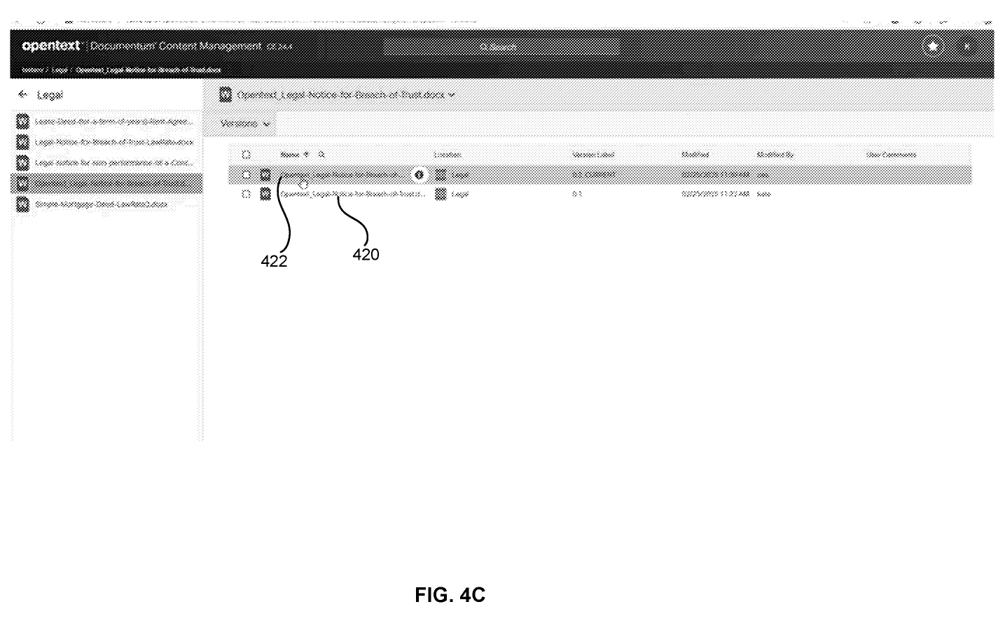

FIG. 4A illustrates an embodiment of a user interface provided by a browser-based CMS client application. In the embodiment of FIG. 4A, the user has navigated through a content management hierarchy to select file 402. The user further selects “Online Editing” option 404 from the context menu. In the background, the CMS checks that the user has permission to edit the file online, checks out the file from the repository, uploads the file and user information to the cloud platform, receives the URL with access token and provides the URL back to the browser. The browser uses the URL to access the file. Turning to FIG. 4B, using the URL causes a browser-based editing client 410 to open in a browser window for editing the online version of the selected file. The user can edit the document. When the user is done editing and closes the file in the browser-based editing client, the CMS will receive a session closed notification for the online version of the file. The CMS checks the file back in, downloads a copy of the online version of the file, stores the downloaded copy to the repository, and deletes the online version from the cloud platform. Using the example of FIG. 4C, while the user may have originally selected one version 420 of the file (e.g., version .1) for online editing, the CMS may store the copy downloaded after online editing as a new version 422 of the file (e.g., version .2).

### Direct Desktop Client Integration Embodiment

In a separate embodiment, the system provides direct desktop client integration with the on-premises content management system through the cloud-based online editing infrastructure. This embodiment enables users to browse and access the authorized folder structure and documents stored in the on-premises repository directly within a native desktop client application without requiring the user to route through a web-based browser client or receive a desktop URL. The architecture leverages the remote editing service server solely for authentication and session management while keeping all permission enforcement, folder enumeration, and document retrieval under on-premises control.

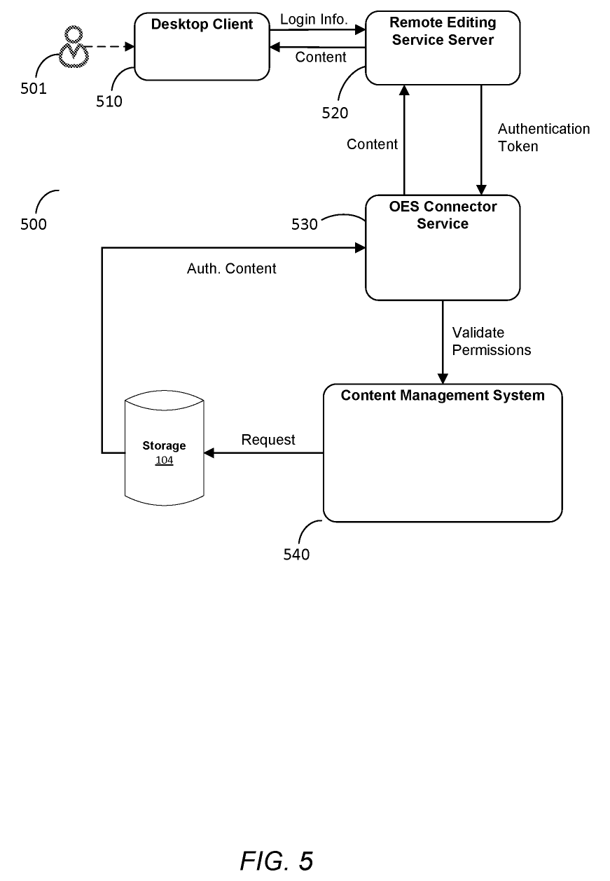

As illustrated in FIG. 5, the direct desktop client integration flow 500 begins when user 501 launches the native desktop client application 510 and enters login credentials. The native desktop client application 510 transmits the login information to the remote editing service server 520. The remote editing service server 520 then initiates an authentication request by calling the on-premises Online Editing Service (OES) connector service 530 via a secure REST API endpoint, passing an authentication token request. In one embodiment, the OES connector service 530 validates the request and returns a scoped JSON Web Token (JWT) containing the user identifier, tenant information, and expiration timestamp. The remote editing service server 520 receives and validates the JSON Web Token using a shared secret or public key.

Upon successful token validation, the OES connector service 530 performs an on-premises permission check against the user’s credentials in the on-premises content management system repository 540. The permission check queries the repository’s access control lists and permission sets associated with the user ID, including folder-level and document-level permissions, inheritance rules, and any role-based restrictions. If the user is authorized, the OES connector service 530 generates a signed folder manifest containing the authorized folder structure, document metadata, and direct-access pointers to the on-premises storage 104. This manifest is returned to the remote editing service server 520, which forwards it securely to the native desktop client application 510. The native desktop client application 510 then renders the authorized folder structure and documents directly within its user interface.

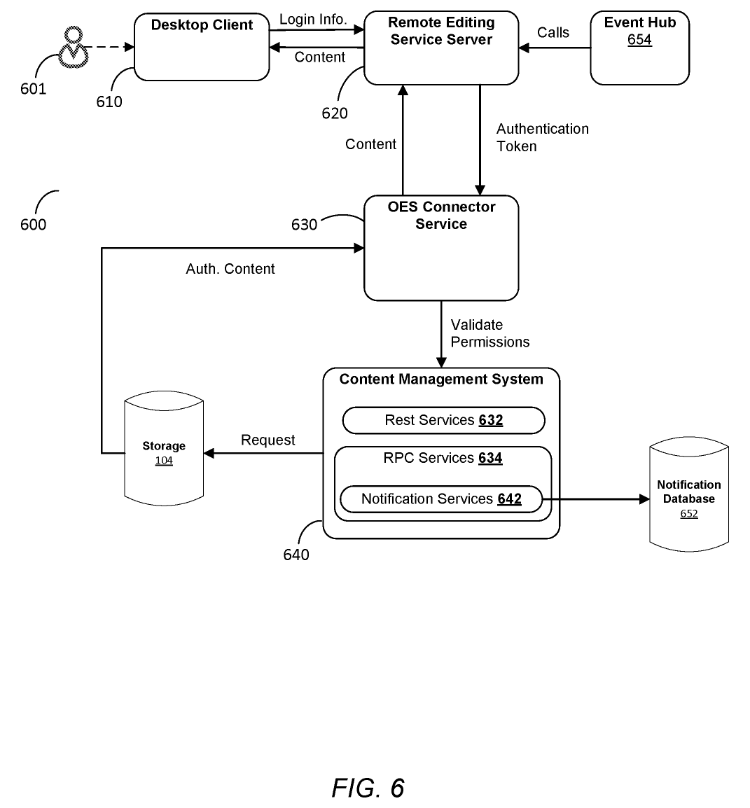

As illustrated in FIG. 6, the high-level architecture 600 of the direct desktop client integration embodiment includes a native desktop client application 610 executing independently on the user’s device, a remote editing service server 620, an on-premises OES connector service 630, and the on-premises content management system 640 managing the repository 604. Unlike conventional approaches that require the user to first authenticate through a web client, the described embodiment establishes a direct authenticated channel between the native desktop client application 610 and the on-premises storage 104 through the remote editing service server 620 and OES connector service 630, thereby preserving full on-premises security and permission controls.

The on-premises content management system provides standard repository features including search and retrieval, access controls via access control lists and permission sets, check-in/check-out locking, version control, and workflow management. In the direct desktop integration embodiment, all permission validation and folder enumeration occur on-premises via the OES connector service 630 before any content is exposed to the remote editing service server.

The OES connector service 630 exposes both REST services 650 for handling authentication and manifest requests, and gRPC-based daemon remote procedure call services 634 for internal communication with other on-premises components. When the OES connector service 630 receives an authentication token request from the remote editing service server 620, it performs token validation, executes the on-premises permission lookup, constructs the folder manifest (containing object IDs, paths, metadata, and access tokens scoped to the specific user session), and returns the manifest to the remote editing service server 620.

In one implementation, the folder manifest is a structured JSON or XML document that includes only those folders and documents for which the user 601 has at least read or read/write permissions according to the on-premises access control lists. The manifest may further include pre-signed, time-limited access URLs or tokens that allow the native desktop client application to retrieve document content directly from the on-premises repository through the authenticated channel. This design ensures that no unauthorized content is ever exposed and that the on-premises system retains complete control over versioning, locking, and auditing.

After the authorized folder structure and documents are provided to the native desktop client application 610, the system further enables the user to initiate online editing or real-time co-authoring sessions using the same OES connector service 630, event hub 654, notification database 652, notification service 642, and heartbeat monitoring mechanisms described for the browser-based embodiment. All subsequent edit sessions remain subject to the same on-premises check-out, version control, and automatic check-in processes, thereby maintaining consistency across both the browser-based and native desktop client integration embodiments.

Those skilled in the relevant art will appreciate that the invention can be implemented or practiced with other computer system configurations including, without limitation, multi-processor systems, network devices, mini-computers, mainframe computers, data processors, and the like. The invention can be employed in distributed computing environments, where tasks or modules are performed by remote processing devices, which are linked through a communications network such as a LAN, WAN, and/or the Internet. In a distributed computing environment, program modules or subroutines may be located in both local and remote memory storage devices. These program modules or subroutines may, for example, be stored or distributed on computer-readable media, including magnetic and optically readable and removable computer discs, stored as firmware in chips, as well as distributed electronically over the Internet or over other networks (including wireless networks).

Embodiments described herein can be implemented in the form of control logic in software or hardware or a combination of both. The control logic may be stored in an information storage medium, such as a computer-readable medium, as a plurality of instructions adapted to direct an information processing device to perform a set of steps disclosed in the various embodiments. Based on the disclosure and teachings provided herein, a person of ordinary skill in the art will appreciate other ways and/or methods to implement the invention. At least portions of the functionalities or processes described herein can be implemented in suitable computer-executable instructions. The computer-executable instructions may reside on a computer readable medium, hardware circuitry or the like, or any combination thereof.

Any suitable programming language can be used to implement the routines, methods, or programs of embodiments of the invention described herein. Different programming techniques can be employed such as procedural or object oriented. Other software/hardware/network architectures may be used. Communications between computers implementing embodiments can be accomplished using any electronic, optical, radio frequency signals, or other suitable methods and tools of communication in compliance with known network protocols.

Particular routines can be executed on a single processor or multiple processors. Although the steps, operations, or computations may be presented in a specific order, this order may be changed in different embodiments. In some embodiments, to the extent multiple steps are shown as sequential in this specification, some combination of such steps in alternative embodiments may be performed at the same time. The sequence of operations described herein can be interrupted, suspended, or otherwise controlled by another process, such as an operating system, kernel, etc. Functions, routines, methods, steps, and operations described herein can be performed in hardware, software, firmware, or any combination thereof.

It will also be appreciated that one or more of the elements depicted in the drawings/figures can be implemented in a more separated or integrated manner or even removed or rendered as inoperable in certain cases, as is useful in accordance with a particular application. Additionally, any signal arrows in the drawings/figures should be considered only as exemplary, and not limiting, unless otherwise specifically noted.

The different aspects described herein may be employed using software, hardware, or a combination of software and hardware to implement and perform the systems and methods disclosed herein. Although specific devices have been recited throughout the disclosure as performing specific functions, one of skill in the art will appreciate that these devices are provided for illustrative purposes, and other devices may be employed to perform the functionality disclosed herein without departing from the scope of the disclosure.

Portions of the methods described herein may be implemented in suitable software code that may reside within RAM, ROM, a hard drive, or other non-transitory storage medium. Alternatively, the instructions may be stored as software code elements on a data storage array, magnetic tape, floppy diskette, optical storage device, or other appropriate data processing system readable medium or storage device.

As used herein, the terms “comprises,” “comprising,” “includes,” “including,” “has,” “having,” or any other variation thereof, are intended to cover a non-exclusive inclusion. For example, a process, product, article, or apparatus that comprises a list of elements is not necessarily limited only to those elements but may include other elements not expressly listed or inherent to such process, product, article, or apparatus.

Furthermore, the term “or” as used herein is generally intended to mean “and/or” unless otherwise indicated. For example, a condition A or B is satisfied by any one of the following: A is true (or present) and B is false (or not present), A is false (or not present) and B is true (or present), and both A and B are true (or present). As used herein, a term preceded by “a” or “an” (and “the” when antecedent basis is “a” or “an”) includes both singular and plural of such term, unless clearly indicated otherwise (i.e., that the reference “a” or “an” clearly indicates only the singular or only the plural). Also, as used in the description herein and throughout the meaning of “in” includes “in” and “on” unless the context clearly dictates otherwise.

Additionally, any examples or illustrations given herein are not to be regarded in any way as restrictions on, limits to, or express definitions of, any term or terms with which they are utilized. Instead, these examples or illustrations are to be regarded as being described with respect to one particular embodiment and as illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms. Language designating such nonlimiting examples and illustrations includes, but is not limited to: “for example,” “for instance,” “e.g.,” “in one embodiment.”

Although the invention has been described with respect to specific embodiments thereof, these embodiments are merely illustrative, and not restrictive of the invention as a whole. Rather, the description is intended to describe illustrative embodiments, features and functions in order to provide a person of ordinary skill in the art context to understand the invention without limiting the invention to any particularly described embodiment, feature or function, including any such embodiment feature or function described in the Abstract or Summary. While specific embodiments of, and examples for, the invention are described herein for illustrative purposes only, various equivalent modifications are possible within the spirit and scope of the invention, as those skilled in the relevant art will recognize and appreciate. As indicated, these modifications may be made to the invention in light of the foregoing description of illustrated embodiments of the invention and are to be included within the spirit and scope of the invention.

Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

1. A method for direct desktop client integration with an on-premises content management system, the method comprising:
receiving, at a remote editing service server, login information transmitted from a native desktop client application;
initiating, by the remote editing service server, an authentication request by calling an on-premises Online Editing Service (OES) connector service via a secure REST API endpoint and passing an authentication token request;
returning, by the OES connector service, a scoped JSON Web Token (JWT) to the remote editing service server;
validating, by the OES connector service upon successful token validation, on-premises permissions of the user by querying access control lists in the on-premises content management system repository;
generating, by the OES connector service when the user is authorized, a signed folder manifest containing only the authorized folder structure, document metadata, and direct-access pointers to the on-premises storage; and
returning the signed folder manifest to the remote editing service server, which forwards the manifest to the native desktop client application so that the authorized folder structure and documents are rendered directly in the native desktop client application without routing through a web-based client.

2. The method of claim 1, wherein the JSON Web Token is scoped to the user identifier and tenant information and includes an expiration timestamp.

3. The method of claim 1, wherein the signed folder manifest is a structured JSON or XML document.

4. The method of claim 1, wherein the signed folder manifest includes pre-signed, time-limited access URLs or tokens that allow the native desktop client application to retrieve document content directly from the on-premises repository.

5. The method of claim 1, wherein the OES connector service performs the permission validation using access control lists that include folder-level permissions, document-level permissions, and inheritance rules.

6. The method of claim 1, further comprising, after providing the authorized folder structure and documents, enabling the native desktop client application to initiate online editing or real-time co-authoring sessions using the OES connector service, an event hub, a notification database, a notification service, and heartbeat monitoring.

7. The method of claim 1, wherein all permission validation and folder enumeration occur on-premises via the OES connector service before any content is exposed to the remote editing service server.

8. A system for direct desktop client integration with an on-premises content management system, the system comprising:
a remote editing service server and an on-premises Online Editing Service (OES) connector service configured to:
receive, at the remote editing service server, login information transmitted from a native desktop client application;
initiate, by the remote editing service server, an authentication request by calling the OES connector service via a secure REST API endpoint and passing an authentication token request;
return, by the OES connector service, a scoped JSON Web Token (JWT) to the remote editing service server;
validate, by the OES connector service upon successful token validation, on-premises permissions of the user by querying access control lists in the on-premises content management system repository;
generate, by the OES connector service when the user is authorized, a signed folder manifest containing only the authorized folder structure, document metadata, and direct-access pointers to the on-premises storage; and
return the signed folder manifest to the remote editing service server, which forwards the manifest to the native desktop client application so that the authorized folder structure and documents are rendered directly in the native desktop client application without routing through a web-based client.

9. The system of claim 8, wherein the JSON Web Token is scoped to the user identifier and tenant information and includes an expiration timestamp.

10. The system of claim 8, wherein the signed folder manifest is a structured JSON or XML document.

11. The system of claim 8, wherein the signed folder manifest includes pre-signed, time-limited access URLs or tokens that allow the native desktop client application to retrieve document content directly from the on-premises repository.

12. The system of claim 8, wherein the OES connector service is configured to perform the permission validation using access control lists that include folder-level permissions, document-level permissions, and inheritance rules.

13. The system of claim 8, wherein the system is further configured, after providing the authorized folder structure and documents, to enable the native desktop client application to initiate online editing or real-time co-authoring sessions using the OES connector service, an event hub, a notification database, a notification service, and heartbeat monitoring.

14. The system of claim 8, wherein all permission validation and folder enumeration occur on-premises via the OES connector service before any content is exposed to the remote editing service server.

15. A non-transitory computer-readable medium storing instructions that, when executed by one or more processors of a remote editing service server and an on-premises Online Editing Service (OES) connector service, cause the one or more processors to perform the following operations for direct desktop client integration with an on-premises content management system:
receiving, at the remote editing service server, login information transmitted from a native desktop client application;
initiating, by the remote editing service server, an authentication request by calling the OES connector service via a secure REST API endpoint and passing an authentication token request;
returning, by the OES connector service, a scoped JSON Web Token (JWT) to the remote editing service server;
validating, by the OES connector service upon successful token validation, on-premises permissions of the user by querying access control lists in the on-premises content management system repository;
generating, by the OES connector service when the user is authorized, a signed folder manifest containing only the authorized folder structure, document metadata, and direct-access pointers to the on-premises storage; and
returning the signed folder manifest to the remote editing service server, which forwards the manifest to the native desktop client application so that the authorized folder structure and documents are rendered directly in the native desktop client application without routing through a web-based client.

16. The non-transitory computer-readable medium of claim 15, wherein the JSON Web Token is scoped to the user identifier and tenant information and includes an expiration timestamp.

17. The non-transitory computer-readable medium of claim 15, wherein the signed folder manifest is a structured JSON or XML document.

18. The non-transitory computer-readable medium of claim 15, wherein the signed folder manifest includes pre-signed, time-limited access URLs or tokens that allow the native desktop client application to retrieve document content directly from the on-premises repository.

19. The non-transitory computer-readable medium of claim 15, wherein the instructions cause the OES connector service to perform the permission validation using access control lists that include folder-level permissions, document-level permissions, and inheritance rules.

20. The non-transitory computer-readable medium of claim 15, wherein the instructions further cause the system, after providing the authorized folder structure and documents, to enable the native desktop client application to initiate online editing or real-time co-authoring sessions using the OES connector service, an event hub, a notification database, a notification service, and heartbeat monitoring.
